(19) United States
(12) Patent Application Publication
(10) Pub. No.: US 2009/0313119 A1
(43) Pub. Date: Dec. 17, 2009

(54) METHOD FOR INCREASING THE AVAILABILITY OF CAPITAL FOR THE PRODUCTION OF FUTURE GOODS, SERVICES AND ACHIEVEMENTS

(76) Inventor: Eliezer ABRAMOVICH, Tel Aviv (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/464,912

(22) Filed: May 13, 2009

Related U.S. Application Data
(60) Provisional application No. 61/052,653, filed on May 13, 2008.

(51) Int. Cl. G06Q 40/00; G06Q 30/00

(52) U.S. Cl. 705/14.49; 705/37

(57) ABSTRACT

A commercial exchange platform, adapted to showcase and promote transactions of wares, services, entitlements or future personal achievements, comprising: at least one computer processing unit, at least one networked database incorporating a means for registering user details and at least one computer memory means for storing details regarding the registered users and the conducted transactions. The registered users may purchase interest or otherwise trade in the entitlements, in the production of the wares, or in the realization of the achievements and services in exchange for a share in their future yield.

### FIELD OF THE INVENTION

The present invention generally pertains to increasing the availability of capital for the production of future goods, services and achievements, and moreover to the trading thereof.

### BACKGROUND OF THE INVENTION

Established commercial entities seeking to expand their business have access to funds from a range of sources spanning from bank loans to the sale of stocks or bonds. Entrepreneurs traditionally solicit funding from potential investors either by direct communication (e.g. phone, fax, mail, e-mail, or face to face meeting), or by general advertisement in promotional media adverts posted in the traditional press, the electronic press or more recently tailored promotional websites. Seeking direct communication with investors is characterized by labor intense actions that are preceded by research. Moreover, typically both corporate and private professional investors are attracted to scalable business initiatives that have a large potential for growth relative to other investment options. They tend to shy away from initiatives of a limited or personal scope (e.g. talent cultivation personal education, realization of art, realization of athletic abilities, realization of personal projects). Furthermore, if they do take interest in such projects, their motivation is either benevolence, public relations or sponsorship similar to that disclosed in U.S. Pat. No. 7,162,429, but rarely are their interests purely investment motivated. By contrast, although the general public might be interested in the yields of such an investment, there is currently no platform to support the interaction between the proposals and the funding. While the general public can invest indirectly (through commercial funds) in scalable initiatives supported by professional investors and can invest directly in companies that are traded on the stock market, the general public lacks an interface for sharing in the initial investment in a particular product or personal achievement in exchange for a share in their future yield. Thus raising funding for realizing particular products and personal achievements is limited to interest carrying loans, or to the benevolence of family, friends and charitable institutions.

It is therefore a well felt need to allow for the interaction between members of the general public who seek to realize a product or a personal achievement and others who take interest in their future yields. Moreover, it is a well felt need to offer a secondary market interface that allows for the exchange of these shares in future yields.

### SUMMARY OF THE INVENTION

It is an object of the present invention to disclose a commercial exchange platform, adapted to showcase wares, services entitlements or future personal achievements, comprising: at least one computer processing unit; at least one networked database; and, at least one computer memory; wherein registered users may purchase interest or otherwise trade in said entitlements, in the production of said wares, or in the realization of said achievements and services in exchange for a share in their future yield.

It is within the scope of the present invention that the wares are selected from a group, including: preproduction wares, prototypes and models.

It is within the scope of the present invention that the achievements are selected from a group including: education, sport, art and self realization.

It is another object of the present invention to disclose a method for increasing the availability of capital for the production of future goods, services and achievements, comprising: obtaining a commercial exchange communication platform adapted to showcase wares and future personal achievements, wherein registered users may purchase interest in the production of said wares and in the realization of said achievements in exchange for a share in their future yield; registering users; accepting adverts for said achievements, services and wares; posting said adverts on said networked platform; noting interest from registered users; and, initiating communication between investors and investment seekers; wherein the general public can invest directly in the future yield of advertised future personal achievements, services or wares.

It is within the scope of the present invention that the method for increasing the availability of capital includes an additional step of trading previously purchased interest between registered users.

It is within the scope of the present invention that the method for increasing the availability of capital includes an additional step of directly communicating between the seekers of investment and the investors.

It is within the scope of the present invention that the communicating step is enabled by means selected from a group, including: mail, e-mail, teleconference, phone, voice over internet protocol and webcam.

It is within the scope of the present invention that the method for increasing the availability of capital includes an additional step of mediating between the seekers of investment and the investors.

It is within the scope of the present invention that the method for increasing the availability of capital includes an additional step of advertising the areas of interest of registered investors.

It is within the scope of the present invention that the method for increasing the availability of capital includes an additional step soliciting future wares and achievements from potential producers.

It is within the scope of the present invention that the method for increasing the availability of capital includes an additional step of authenticating the user.

It is within the scope of the present invention that the method for increasing the availability of capital includes an additional step of registering a user's investment interests.

It is within the scope of the present invention that the method for increasing the availability of capital includes an additional step of indicating the degree of interest or investment already achieved.

It is within the scope of the present invention that the method for increasing the availability of capital includes an additional step of charging a mediation fee.

It is within the scope of the present invention that the method for increasing the availability of capital includes an additional step of informing registered users of adverts that meet their registered interests.

It is within the scope of the present invention that the method for increasing the availability of capital includes an additional step of holding funds invested in trusteeship.

It is within the scope of the present invention that the method for increasing the availability of capital includes an additional step of opening a proprietary bank account for the deposit and display of the investment.

It is within the scope of the present invention that the method for increasing the availability of capital includes an additional step of limiting the share in the yield to a particular time frame or ceiling.

It is within the scope of the present invention that the ceiling is either relative or absolute.

It is within the scope of the present invention that the method for increasing the availability of capital includes an additional step of rallying together by a group of registered users in order to showcase a combined or integrated product or achievement.

It is within the scope of the present invention that the mediating step is enacted by a trustee for the funds.

It is within the scope of the present invention that the mediating step is enacted by a bank and including an additional step of issuing a letter of credit to the investment seeker.

It is within the scope of the present invention that the mediating step is enacted by a bank and including and additional step of investing the investments in a proprietary bank account.

It is within the scope of the present invention that the method for increasing the availability of capital includes an additional step of making a statement of said account viewable to said investors.

It is within the scope of the present invention that the method for increasing the availability of capital includes an additional step of publicizing a profile of past transactions of registered users.

It is within the scope of the present invention that the method for increasing the availability of capital includes an additional step of generating an interactive feedback and rating system of registered users.

It is within the scope of the present invention that the method for increasing the availability of capital includes an additional step selected from a group, in including: filtering, searching or browsing said adverts.

It is yet another object of the present invention to disclose a method for dividing the income or profit from entitlements, wares or personal achievements comprising: obtaining a commercial exchange communication platform adapted to showcase entitlements, wares and future personal achievements, wherein registered users may purchase interest in the production of said wares and in the realization of said entitlements or achievements in exchange for a share in their future yield; registering users; accepting adverts for said achievements, services and wares; posting said adverts on said networked platform; noting interest from registered users; and, initiating communication between investors and investment seekers; wherein the general public can trade in shares of the future yield of advertised entitlements, future personal achievements, services or wares.

It is within the scope of the present invention that the method for dividing the income or profit includes an additional step of trading previously purchased interest between registered users.

It is within the scope of the present invention that the method for dividing the income or profit includes an additional step of directly communicating between the seekers of investment and the investors.

It is within the scope of the present invention that the communicating step is enabled by means selected from a group, including: mail, e-mail, teleconference, phone, voice over internet protocol and webcam.

It is within the scope of the present invention that the method for dividing the income or profit includes an additional step of mediating between the seekers of investment and the investors.

It is within the scope of the present invention that the method for dividing the income or profit includes an additional step of advertising the areas of interest of registered investors.

It is within the scope of the present invention that the method for dividing the income or profit includes an additional step soliciting future wares and achievements from potential producers.

It is within the scope of the present invention that the method for dividing the income or profit includes an additional step of authenticating the user.

It is within the scope of the present invention that the method for dividing the income or profit includes an additional step of registering a user's investment interests.

It is within the scope of the present invention that the method for dividing the income or profit includes an additional step of indicating the degree of interest or investment already achieved.

It is within the scope of the present invention that the method for dividing the income or profit includes an additional step of charging a mediation fee.

It is within the scope of the present invention that the method for dividing the income or profit includes an additional step of informing registered users of adverts that meet their registered interests.

It is within the scope of the present invention that the method for dividing the income or profit includes an additional step of holding funds invested in trusteeship.

It is within the scope of the present invention that the method for dividing the income or profit includes an additional step of opening a proprietary bank account for the deposit and display of the investment.

It is within the scope of the present invention that the method for dividing the income or profit includes an additional step of limiting the share in the yield to a particular time frame or ceiling.

It is within the scope of the present invention that the ceiling is either relative or absolute.

It is within the scope of the present invention that the method for dividing the income or profit includes an additional step of rallying together by a group of registered users in order to showcase a combined or integrated product or achievement.

It is within the scope of the present invention that the mediating step is enacted by a trustee for the funds.

It is within the scope of the present invention that the mediating step is enacted by a bank and including an additional step of issuing a letter of credit to the investment seeker.

It is within the scope of the present invention that the mediating step is enacted by a bank and including and additional step of investing the investments in a proprietary bank account.

It is within the scope of the present invention that the method for dividing the income or profit includes an additional step of making a statement of said account viewable to said investors.

It is within the scope of the present invention that the method for dividing the income or profit includes an additional step of publicizing a profile of past transactions of registered users.

It is within the scope of the present invention that the method for dividing the income or profit includes an additional step of generating an interactive feedback and rating system of registered users.

It is within the scope of the present invention that the method for dividing the income or profit includes an additional step selected from a group, in including: filtering, searching or browsing said adverts.

It is yet another object of the present invention to disclose a method for trading shares in entitlements, wares or personal achievements comprising: obtaining a commercial exchange communication platform adapted to showcase entitlements, wares and future personal achievements, wherein registered users may purchase interest in the production of said wares and in the realization of said entitlements or achievements in exchange for a share in their future yield; registering users; accepting adverts for said achievements, services and wares; posting said adverts on said networked platform; noting interest from registered users; and, initiating communication between investors and investment seekers; wherein the general public can trade in shares of the future yield of advertised entitlements, future personal achievements, services or wares.

It is within the scope of the present invention that the method for trading shares includes an additional step of trading previously purchased interest between registered users.

It is within the scope of the present invention that the method for trading shares includes an additional step of directly communicating between the seekers of investment and the investors.

It is within the scope of the present invention that the communicating step is enabled by means selected from a group, including: mail, e-mail, teleconference, phone, voice over internet protocol and webcam.

It is within the scope of the present invention that the method for trading shares includes an additional step of mediating between the seekers of investment and the investors.

It is within the scope of the present invention that the method for trading shares includes an additional step of advertising the areas of interest of registered investors.

It is within the scope of the present invention that the method for trading shares includes an additional step soliciting future wares and achievements from potential producers.

It is within the scope of the present invention that the method for trading shares includes an additional step of authenticating the user.

It is within the scope of the present invention that the method for trading shares includes an additional step of registering a user's investment interests.

It is within the scope of the present invention that the method for trading shares includes an additional step of indicating the degree of interest or investment already achieved.

It is within the scope of the present invention that the method for trading shares includes an additional step of charging a mediation fee.

It is within the scope of the present invention that the method for trading shares includes an additional step of informing registered users of adverts that meet their registered interests.

It is within the scope of the present invention that the method for trading shares includes an additional step of holding funds invested in trusteeship.

It is within the scope of the present invention that the method for trading shares includes an additional step of opening a proprietary bank account for the deposit and display of the investment.

It is within the scope of the present invention that the method for trading shares includes an additional step of limiting the share in the yield to a particular time frame or ceiling.

It is within the scope of the present invention that the ceiling is either relative or absolute.

It is within the scope of the present invention that the method for trading shares includes an additional step of rallying together by a group of registered users in order to showcase a combined or integrated product or achievement.

It is within the scope of the present invention that the mediating step is enacted by a trustee for the funds.

It is within the scope of the present invention that the mediating step is enacted by a bank and including an additional step of issuing a letter of credit to the investment seeker.

It is within the scope of the present invention that the mediating step is enacted by a bank and including and additional step of investing the investments in a proprietary bank account.

It is within the scope of the present invention that the method for trading shares includes an additional step of making a statement of said account viewable to said investors.

It is within the scope of the present invention that the method for trading shares includes an additional step of publicizing a profile of past transactions of registered users.

It is within the scope of the present invention that the method for trading shares includes an additional step of generating an interactive feedback and rating system of registered users.

It is within the scope of the present invention that the method for trading shares includes an additional step selected from a group, in including: filtering, searching or browsing said adverts.

### BRIEF DESCRIPTION OF THE FIGURES

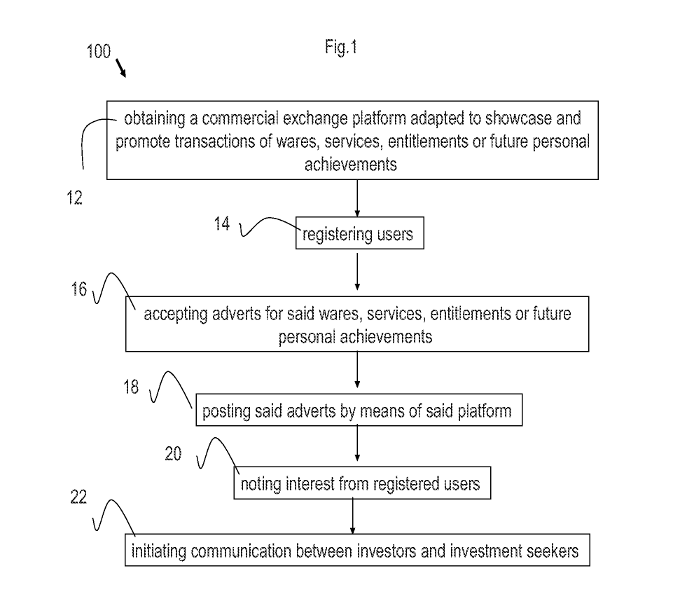

In order to better understand the invention and its implementation in practice, a plurality of embodiments will now be described, by way of non-limiting example only, with reference to the accompanying drawings, in which FIG. 1 depicts a particular embodiment of a method for showcasing and promoting wares, services, entitlements or future personal achievements wares.

### DETAILED DESCRIPTION OF THE PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a method for allowing for the interaction between members of the general public who seek investment in a product or personal achievements and others who would like to investment in these initiatives in exchange for the promise of future yields.

The method of the present invention has many technological advantages, among them: Cost Efficiency; Diversifying market products; generating capital influx; additional features and advantages of the invention will become apparent from the following drawings and description.

Reference is made now to FIG. 1 illustrating particular embodiment 100 of a method for increasing the availability of capital for the production of future goods, services, entitlements and achievements comprising the steps of: 12 obtaining a commercial exchange platform adapted to showcase and promote transactions of wares, services; entitlements or future personal achievements; 14 registering users; 16 accepting adverts for said wares, services, entitlements or future personal achievements; 18 posting said adverts by means of said platform; 20 noting interest from registered users; and, 22 initiating communication between investors and investment seekers. The term ‘wares’ refers hereinafter to current or future property that is legally held by at least one legal entity.

The term ‘entitlement’ refers hereinafter to the rights to future or current benefits.

The term ‘share’ refers hereinafter to a share, an option or a right to participate in profits, income or any other rights resulting from the realization of wares or personal achievements.

### EXAMPLES

A tennis player advertises the sale of a share in his future profits from upcoming tournaments.

An inventor advertises the sale of a share in the future proceeds from a patent application.

An insurance claimant advertises the sale of a share in a future insurance claim.

An artist advertises the sale of a share in the proceeds from a future endeavor.

1. A commercial exchange platform, adapted to showcase and promote transactions of wares, services, entitlements or future personal achievements, comprising:
a. at least one computer processing unit;
b. at least one networked database incorporating a means for registering user details; and,
c. at least one computer memory means for storing details regarding said registered users and said conducted transactions;
wherein registered users may purchase interest or otherwise trade in said entitlements, in the production of said wares, or in the realization of said achievements and services in exchange for a share in their future yield

2. The commercial exchange platform according to claim 1 wherein said wares are selected from a group, including: preproduction wares, prototypes and models.

3. The commercial exchange platform according to claim 1 wherein said achievements are selected from a group including: education, sport, art and self realization.

4. A method for increasing the availability of capital for the production of future goods, services, entitlements and achievements, wherein the general public can invest directly in the future yield of advertised items, comprising:
a. obtaining a commercial exchange platform adapted to showcase and promote transactions of wares, services, entitlements or future personal achievements;
b. registering users;
c. accepting adverts for said wares, services, entitlements or future personal achievements;
d. posting said adverts by means of said platform;
e. noting and registering interest from registered users; and,
f. initiating communication between investors and investment seekers

5. The method for increasing the availability of capital according to claim 4, including an additional step of trading in previously occurring investments between registered users.

6. The method for increasing the availability of capital according to claim 4, including an additional step of directly communicating between the seekers of investment and the investors; said communicating step is enabled by means selected from a group, including: mail, e-mail, teleconference, phone, voice over internet protocol and webcam.

7. The method for increasing the availability of capital according to claim 4, including an additional step of mediating between the seekers of investment and the investors;

8. The method for increasing the availability of capital according to claim 7, wherein said mediating between the seekers of investment and the investors is enacted by a trustee for the funds or by a investing said investments in a proprietary bank account and including additional steps of issuing a letter of credit to the investment seeker and making a statement of said account viewable to said investors.

9. The method for increasing the availability of capital according to claim 4, including an additional step of advertising the areas of interest of registered investors.

10. The method for increasing the availability of capital according to claim 4, including an additional step soliciting future wares and achievements from potential producers.

11. The method for increasing the availability of capital according to claim 4, additionally comprising a step of authenticating the user.

12. The method for increasing the availability of capital according to claim 4, additionally comprising a step of indicating the degree of interest or investment already in a particular item.

13. The method for increasing the availability of capital according to claim 4, additionally comprising a step of charging a mediation fee.

14. The method for increasing the availability of capital according to claim 4, additionally comprising a step of holding funds invested in trusteeship.

15. The method for increasing the availability of capital according to claim 4, additionally comprising a step of opening a proprietary bank account for the deposit and display of said investment.

16. The method for increasing the availability of capital according to claim 4, including an additional step of limiting said share in said yield to a particular time frame or ceiling; said ceiling is either relative or absolute.

17. The method for increasing the availability of capital according to claim 4, including an additional step of rallying together by a group of registered users in order to showcase a combined or integrated product or achievement.

18. The method for increasing the availability of capital according to claim 4, including an additional step of generating an interactive feedback and rating system of registered users.

19. The method for increasing the availability of capital according to claim 4, adapted to include an additional step selected from a group, in including: filtering, searching or browsing said adverts and past transactions of registered users.

20. The method for increasing the availability of capital according to claim 4, adapted for dividing the income or profit from entitlements, wares or personal achievements.
